(19) United States
(12) Patent Application Publication
(10) Pub. No.: US 2005/0022647 A1
(43) Pub. Date: Feb. 3, 2005

(54) Anti-tilt device for arm of band saw

(76) Inventor: Bin Chun Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,665

(22) Filed: Jul. 28, 2003

(51) Int. Cl. B23D 55/00; B27B 13/00

(52) U.S. Cl. 83/794; 83/813

(57) ABSTRACT

An anti-tilt device for band saw includes an L-shaped member having a horizontal portion fixed on the table of the band saw and a vertical portion which has an inclined surface. The band saw includes a base on a top of the table and a connection member has an end pivotably connected to the base and the other end of the connection member is pivotably connected to an arm. A saw blade is connected to the arm. The inclined surface on the vertical portion faces the connection member of the band saw so as to limit the maximum angle that the connection member is pivoted.

### FIELD OF THE INVENTION

The present invention relates to a band saw that has an anti-tilt device on the table so as to prevent the arm of the band saw from over tilting.

### BACKGROUND OF THE INVENTION

A conventional band saw 10 is shown in FIG. 1 and generally includes a table 11 and a base 12 is fixed on a top of the table 11 so that a connection member 13 is pivotably connected to the table 11. An arm 14 is connected to the connection member 13 and a saw blade 15 is connected to the remote end of the arm 14. A object (not shown) to be cut can be put on the table 11 and beneath the saw blade 15 so that the arm 14 can be pivoted an angle about a connection point on the connection member 13 in order to position the object to be cut, then the arm 14 is pivoted downward to cut the object. Nevertheless, when pivoting the arm 14, if the heavy arm 14 is pivoted a large angle, the center of weight of the band saw 10 is shifted and the whole set of the band saw 10 could fall.

The present invention intends to provide an anti-tilt device for band saw and the device includes a stop member on the table so as to limit the maximum angle that the arm can be pivoted.

### SUMMARY OF THE INVENTION

In accordance with one aspect of the present invention, there is provided an anti-tilt device for band saw which includes a table with a base connected to a top thereof and a connection member has an end pivotably connected to the base and the other end of the connection member is pivotably connected to an arm. A saw blade is connected to the arm. The anti-tilt device comprises an L-shaped member having a horizontal portion fixed on the table and a vertical portion which is located beside the connection member so as to prevent the connection member from over pivoting during use.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show a conventional band saw;

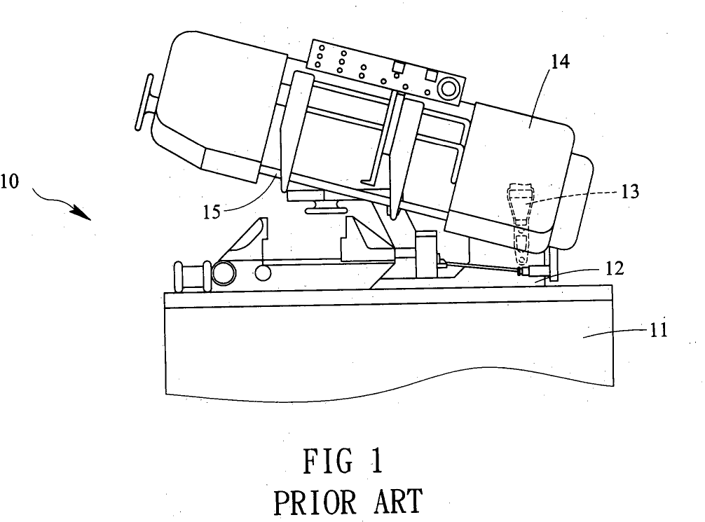

FIG. 2 shows the anti-tilt device of the present invention is connected to the table of the band saw;

FIG. 3 is an exploded view to show the anti-tilt device of the present invention;

FIG. 4 shows a cross sectional view of the anti-tilt device of the present invention;

FIG. 5 shows the L-shaped member of the anti-tilt device of the present invention is pivotable about the bolt;

FIG. 6 shows the vertical portion of the L-shaped member can be pivoted away from the connection member.

### DETAILED DESCRIPTION OF THE PREFERRED EMBODIMENT

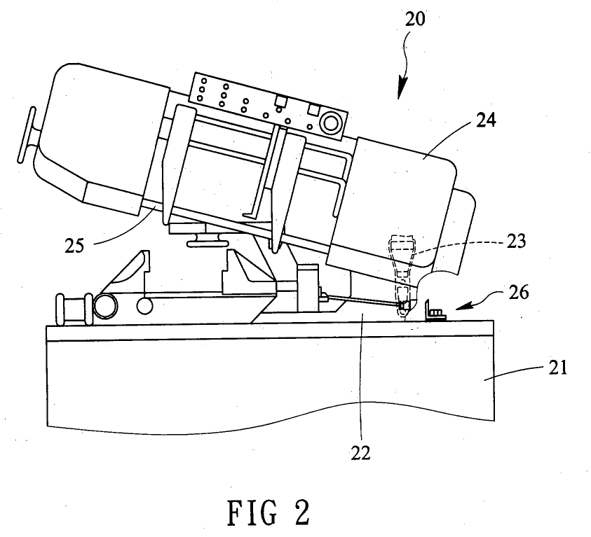

Referring to FIG. 2, a band saw 20 includes a table 21 with a base 22 connected to a top of the table 21 and a connection member 23 has an end pivotably connected to the base 22 and the other end of the connection member 23 is pivotably connected to an arm 24. A saw blade 25 is connected to the arm 24 and driven by a motor in the arm 24.

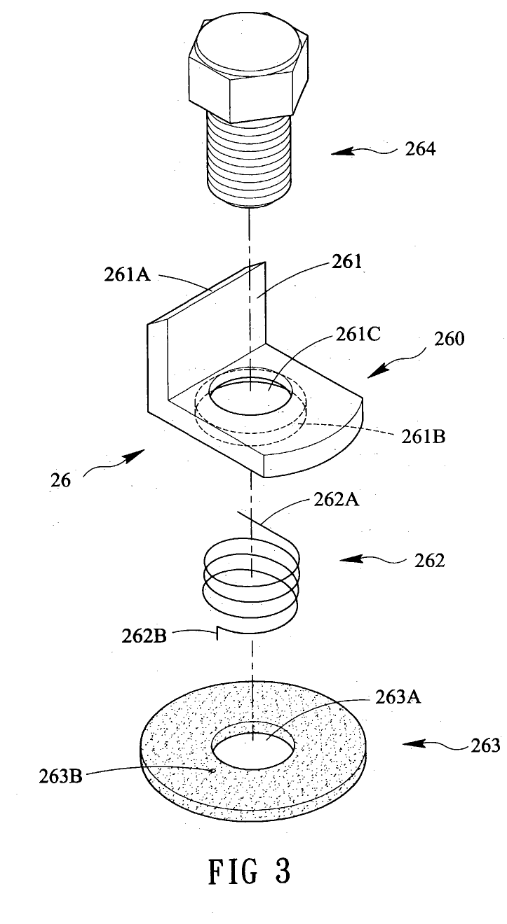

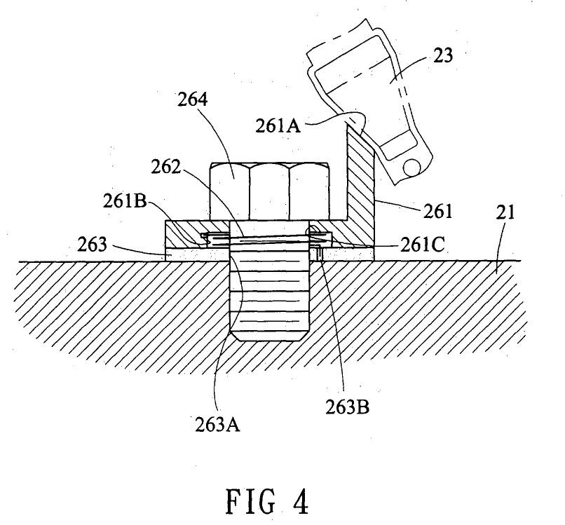

Further referring to FIGS. 3 and 4, the anti-tilt device for the anti-tilt device of the present invention comprises a stationary ring 263 fixed on the top of the table 21 and a central hole 263A is defined through the stationary ring 263. A hole 263B is defined in the stationary ring 263. An L-shaped member 26 having a horizontal portion 260 which is rested on the stationary ring 263, and a vertical portion 261. The vertical portion 261 is located beside the connection member 23 and has an inclined surface 261A which faces the connection member 23.

A bolt 264 extends through a hole 261C defined through the horizontal portion 260 and the central hole 263A in the stationary ring 263 so as to position the L-shaped member 26 and the stationary ring 263 on the table 21. A recess 261B is defined in an underside of the horizontal portion 260 and a torsion spring 262 is received in the recess 261B and mounted to the bolt 264. A first end 262B of the torsion spring 262 is inserted in the hole 263B in the stationary ring 263 and a second end 262A of the torsion spring 262 is inserted in a cavity defined in an inner periphery of the hole 261C of the horizontal portion 260.

When operating the arm 24 at its maximum angle, the connection member 23 is stopped by the inclined surface 261A of the vertical portion 261 so that the arm 24 is effectively prevented from being over pivoted.

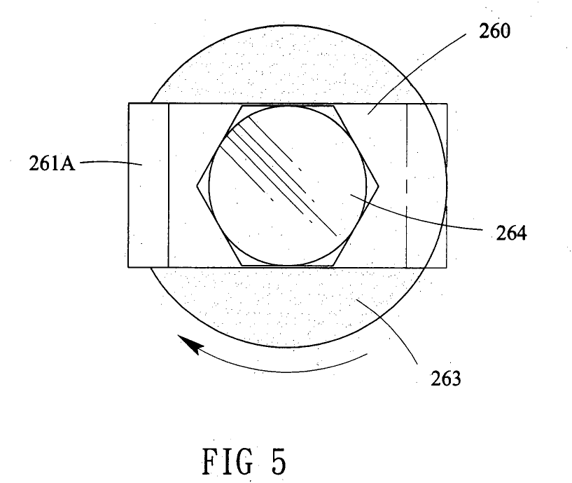

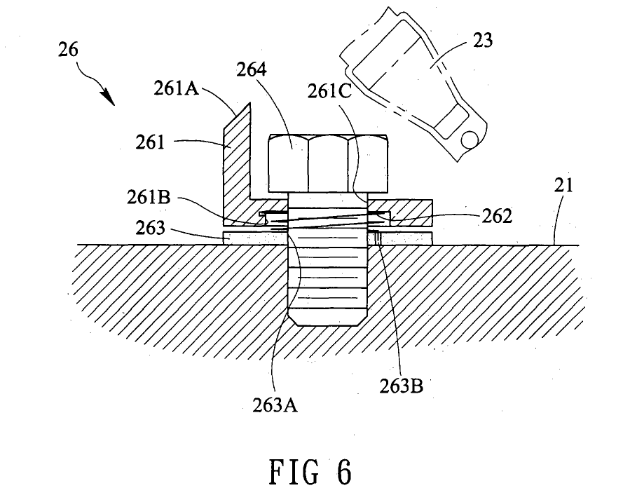

Referring to FIGS. 5 and 6, L-shaped member 26 can be rotated about the bolt 264 when the bolt 264 is loosened. The vertical portion 261 is able to be swung away from the connection member 23 and the connection member 23 is then can be pivoted a larger angle as shown in FIG. 6. It is to be noted that when the bolt 264 is loosened, the L-shaped member 26 can be automatically rotated back to its original position by the torsion spring 262.

While we have shown and described the embodiment in accordance with the present invention, it should be clear to those skilled in the art that further embodiments may be made without departing from the scope of the present invention.

1. An anti-tilt device for band saw which includes a table with a base connected to a top of the table, a connection member having an end pivotably connected to the base and the other end of the connection member pivotably connected to an arm, a saw blade connected to the arm, the anti-tilt device comprising:
an L-shaped member having a horizontal portion and a vertical portion, the horizontal portion adapted to be connected to the table and the vertical portion being adapted to be located beside the connection member.

2. The device as claimed in claim 1, wherein the vertical portion has an inclined surface which is adapted to face the connection member.

3. The device as claimed in claim 1, wherein a bolt extends through a hole defined through the horizontal portion and is adapted to be fixed to the table.

4. The device as claimed in claim 3 further comprising a torsion spring mounted to the bolt and received in a recess defined in an underside of the horizontal portion, a first end of the torsion spring adapted to be fixed to the table and a second end of the torsion spring fixed to an inner periphery of the hole of the horizontal portion.

5. The device as claimed in claim 4 further comprising a stationary ring adapted to be fixed on the table and the horizontal portion rested on the stationary ring, the first end of the torsion spring being inserted in a hole defined in the stationary ring.
